(19) United States
(12) Patent Application Publication
(10) Pub. No.: US 2025/0188349 A1
(43) Pub. Date: Jun. 12, 2025

(54) SUPPRESSION OF MANGANESE DIOXIDE FORMATION IN MANGANESE (III)-BASED ETCHING SOLUTIONS

(71) Applicant: MacDermid Enthone Inc., Waterbury, CT (US)

(72) Inventors: Roderick D. Herdman, Kingsbury (GB); Roshan V. Chapaneri, Coventry (GB)

(21) Appl. No.: 18/534,907

(22) Filed: Dec. 11, 2023

(51) Int. Cl. C09K 13/04

(52) U.S. Cl. CPC C09K 13/04

(57) ABSTRACT

A method is provided for stabilizing manganese(III)-based etching solutions containing manganese(III) ions and one or more acids, in which the one or more acids have a concentration of at least 18 molar acidity. The method includes the step of adding an effective amount of one or more stabilizing metal ions to the etching solution. The stabilizing metal ions eliminate or at least substantially reduce the tendency of the etching solution to form manganese dioxide during extended operation of the solution in long-term production plant operations and prevent any resulting build-up of manganese dioxide precipitate on surfaces.

### FIELD OF THE INVENTION

The present invention relates generally to methods of suppressing the formation of manganese dioxide in manganese(II)-based etching solutions.

### BACKGROUND OF THE INVENTION

It is well known in the art to plate non-conductive substrates, (i.e. plastics) with metal for a variety of purposes. Plastic mouldings are relatively inexpensive to produce and metal plated plastic is used for many applications. For example, metal plated plastics are used for decoration and for the fabrication of electronic devices. An example of a decorative use includes automobile parts such as trim. Examples of electronic uses include printed circuits, wherein metal plated in a selective pattern comprises the conductors of the printed circuit board, and metal plated plastics used for EMI shielding.

ABS resins are one of the most commonly plated plastics for decorative purposes while phenolic and epoxy resins are the most commonly plated plastics for the fabrication of printed circuit boards.

Preparing plastics for subsequent plating is a multistep process and typical process steps include:
1) etching the substrate with an etching solution, for example chromic acid;
2) neutralizing the etched surface with a neutralizing solution:
3) activating the etched surface, for example using a colloidal palladium-tin activator;
4) removing unwanted residual components, e.g. tin, with an accelerating step; and
5) depositing a layer of electroless copper or electroless nickel followed by electrolytic copper and/or nickel plating.

The etching step introduces microroughness on the substrate surface in order to provide mechanical adhesion of the subsequent metallic coatings and to provide a suitable surface for adsorption of a catalytic layer (commonly palladium, applied by immersion in a solution of colloidal palladium particles). The catalyst is applied in order to catalyse deposition of the initial metallic layer from an autocatalytic nickel or copper plating process. Following this, deposits of copper, nickel and/or chromium are typically applied by electroplating.

The initial etching of the plastic components is an essential part of the overall process and the most commonly used types of plastic for electroplating are acrylonitrile/butadiene/styrene (ABS) or a blend of this material with polycarbonate (ABS/PC). These substrates are popular because they are relatively easy to treat. ABS consists of two phases, a relatively hard phase consisting of an acrylonitrile/styrene copolymer and a softer polybutadiene phase. The etching solution attacks the softer polybutadiene phase which is effectively removed from the surface of the substrate to create the microroughness.

Currently, plastic substrates are etched almost exclusively using a mixture of chromic and sulphuric acids which is highly effective as an etchant for ABS and ABS/PC. However, chromic acid is a recognised carcinogen and mutagen and is highly toxic. Due to increasing global regulation of chemicals, it is desirable to replace chromic acid with safer alternatives. In particular, in Europe, regulatory authorities are soon expected to severely restrict the use of chromic acid. Additional pressure to eliminate chemicals such as chromic acid in the supply chain is also coming from end users such as automotive manufacturers. In response, many alternative processes have been proposed and marketed, and these are predominantly focused on manganese-based compounds.

The use of permanganate in conjunction with acid for the etching of plastic substrates was described, for example, in U.S. Pat. No. 4,610,895 to Tubergen et al., the subject matter of which is herein incorporated by reference in its entirety. Later, the use of permanganate in conjunction with an ionic palladium activation process was described in U.S. Pat. Pub. No. 2005/0199587 to Bengston et al., the subject matter of which is herein incorporated by reference in its entirety. The use of permanganate solutions with sulphuric acid and also containing perhalo ions (e.g., perchlorate or periodate) was described in U.S. Pat. No. 8,394,289 to Satou et al., the subject matter of which is herein incorporated by reference in its entirety. More recently, the use of permanganate ions in acidic solution in the absence of alkali metal or alkaline earth metal ions was described in U.S. Pat. No. 9,752,074 to Schildmann et al., the subject matter of which is herein incorporated by reference in its entirety. Schildmann additionally describes the use of ions such as Ag, Bi, V, Mo, and Cu to increase the efficiency of anodic oxidation.

U.S. Pat. No. 10,174,250 to Middeke et al., the subject matter of which is herein incorporated by reference in its entirety, describes etching solutions containing manganese(VII) ions (permanganate) and 0.02-0.6 M of monobasic acid plus an extensive list of metal ions (titanium, zirconium, niobium, molybdenum, ruthenium, rhodium, nickel, copper, silver, zinc and cadmium) that is claimed to prevent manganese dioxide formation resulting from the decomposition of manganese(VII) ions in these solutions. However, only copper showed any significant effect and was the most preferred for stabilizing the manganese(VII) ions.

Therefore, it can be seen that the use of certain metal ions has been suggested in the prior art for the purpose of aiding in the generating of or stabilizing manganese(VII) as the permanganate ion.

The tendency for permanganate based solutions to form sludge and undergo self-decomposition is well known. Under strongly acidic conditions, permanganate ions can react with hydrogen ions to produce manganese(II) ions and water according to the following reaction:

4MnO₄⁻+12H⁺→4Mn²⁺+6H₂O+5O₂ (1)

The manganese(II) ions formed by this reaction can then undergo further reaction with permanganate ions, forming a sludge of manganese dioxide according to the following reaction:

2MnO₄⁻+2H₂O+3Mn²⁺→5MnO₂+4H⁺ (2)

Thus, it can be seen that formulations based on strongly acidic permanganate solutions are intrinsically unstable irrespective of whether the permanganate ion is added by alkali metal salts of permanganate or is electrochemically generated in situ. In comparison to the currently used chromic acid etchants, the poor chemical stability of acidic permanganate renders it effectively useless for large-scale commercial applications.

Alkaline permanganate etches are more stable, and are widely used in the printed circuit board industry for etching epoxy based printed circuit boards. However, alkaline permanganate is not an effective etchant for plastics such as ABS or ABS/PC, and manganese(VII) is unlikely to gain widespread commercial acceptance as an etchant for these materials.

The use of vanadium (as vanadium pentoxide) was previously proposed in WO2018/115338A1 as an etching agent in combination with manganese and a mixture of acids.

U.S. Pat. No. 10,280,367 to Pearson et al., the subject matter of which is herein incorporated by reference in its entirety, describes a solution of trivalent manganese ions in strongly acidic solution that is capable of etching ABS. Trivalent manganese is highly oxidising but unstable in aqueous solutions because it very rapidly disproportionates to manganese dioxide and divalent manganese via the following reaction:

2Mn³⁺+2H₂O→MnO₂+Mn²⁺+4H⁺

However, Pearson demonstrated that in strong sulphuric acid solutions (e.g., 9-15M sulphuric acid, equivalent to 18-30M as a monobasic acid), trivalent manganese ions form a stable purple coloured solution that is a suitable medium for the etching of ABS and ABS/PC substrates. The preferred method of creating trivalent manganese in these solutions is by electrolysis, where manganese(II) is oxidised to manganese(III) at the anode.

Over long periods of time in industrial use, these manganese(III)-based etching solutions still form small amounts of manganese dioxide and while some of the manganese dioxide (also known as manganese(IV) oxide) can be removed by filtration, it is not totally removed. Over a period of some months, a brown film can build up on the tank walls and inside pipework, leading to the need to pump out the solution and clean the tank. This is undesirable because valuable production time is lost.

The prior art provides no suggestion for suppressing manganese dioxide in manganese(III)-based etching solutions which can lead to build-up of manganese dioxide precipitate on surfaces of tank walls and inside pipework. Thus there remains a need in the art for an improved process for suppressing and/or at least substantially eliminating the formation of manganese dioxide in manganese(III)-based etching solutions.

### SUMMARY OF THE INVENTION

It is an object of the present invention to provide a process for the suppression of manganese dioxide in manganese(I)-based etching solutions.

It is another object of the present invention to provide a process for at least substantially eliminating the formation of manganese dioxide in manganese(III)-based etching solutions.

It is another object of the present invention to prevent the formation of manganese dioxide from manganese(III)-based etching solution that can lead to a build-up of manganese dioxide precipitate on surfaces contained in a system comprising a tank containing the etching solution and associated pipework.

The current invention comprises a method for the stabilisation of etching solutions containing dissolved manganese (III) ions and at least one acid, in which the acid has a concentration of at least 18 molar acidity, in order to eliminate or reduce the formation of undesirable manganese dioxide precipitate in the manganese(III)-based etch solution that can lead to a build-up of precipitate on surfaces of tank containing the etching solution. The method involves the addition of an effective amount of suitable stabilizing metal ions to the etching solution, which stabilizing metals may be selected from aluminium, titanium and chromium, and which may be used alone or in combination.

### BRIEF DESCRIPTION OF THE FIGURES

FIG. 1 is a photograph showing the brown precipitate resulting from the etching solution of Reference Example 1.

FIG. 2 is a photograph showing the black sludge that formed during electrolysis using the solution described in Reference Example 5.

FIG. 3 is a photograph showing the brown precipitate that formed when using iron as the source of the stabilizing metal ions in the etching solution described in Reference Example 7.

FIG. 4 is a photograph of the etching solution prepared in accordance with Reference Example 14 and showing the brown precipitation that formed after 4 days of elevated heat treatment.

FIG. 5 is a photograph of the etching solution prepared in accordance with Invention Example 15 and shows that no precipitate formed after 14 days of elevated heat treatment.

### DETAILED DESCRIPTION OF THE INVENTION

The present invention relates generally to an improved method of suppressing and/or substantially eliminating the formation of manganese dioxide in manganese(III)-based etching solutions and any resulting build-up of manganese dioxide precipitate on surfaces of the system, including the tank in which the manganese(III)-based etching solution is contained.

According to the present invention, a method is provided for stabilizing manganese(III)-based etching solutions containing manganese(III) ions and one or more acids, wherein the method comprises adding an effective amount of stabilizing metal ions to the etching solution. The stabilizing metal ions eliminate or at least substantially reduce the tendency of the manganese(III)-based etching solution to form manganese dioxide during extended operation of the solution in long-term production plant operations. By “long-term production plant operations” what is meant is that the etching solution does not form manganese dioxide when operated for a period of at least a month, preferably at least several months, most preferably up to a year or longer. In addition, surfaces of the system (including walls and bottom of the tank, associated pipework, etc.) remain free of any visible formation of manganese dioxide precipitate for at least a month, preferably at least several months, most preferably up to a year or longer.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath,” “below,” “lower,” “above,” “upper,” and the like, are used for ease of descriptions to describe one element or feature's relationship to another element(s) or feature(s) as illustrated in the figures. It is further understood that the terms “front” and “back” are not intended to be limiting and are intended to be interchangeable where appropriate.

As used herein, the terms “comprises” and/or “comprising” specify the presence of stated features, integers, steps, operations, elements, and/or components, but do not preclude the presence or addition of one or more other features, integers, steps, operations, elements, components, and/or groups thereof.

As used herein, the term “substantially-free” or “essentially-free,” if not otherwise defined herein for a particular element or compound, means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytical methods.

As used herein, the terms “manganese dioxide” and “manganese(IV) oxide” are used interchangeably.

In one embodiment, the present invention relates generally to a manganese(III)-based etching solution for treating plastic surfaces comprising:
dissolved manganese(II) ions and dissolved manganese(III) ions;
at least one acid, wherein the at least one acid has a concentration of at least 18 molar acidity; and
at least one stabilizing metal ion selected from the group consisting of aluminum, titanium, chromium, and combinations thereof.

The present invention also relates generally to a process comprising:
(a) providing a substrate comprising one or more polymers;
(b) providing a manganese(III)-based etching solution comprising:
   (i) dissolved manganese(II) ions and dissolved manganese(III) ions;
   (ii) at least one acid, wherein the at least one acid has a concentration of at least 18 molar acidity; and
   (iii) at least one stabilizing metal ion selected from the group consisting of aluminum, titanium, chromium, and combinations thereof; and
(c) contacting a surface of the substrate comprising the one or more polymers with the manganese(II)-based etching solution to etch the surface of the substrate.

Suitable stabilizing metal ions include metal ions selected from the group consisting of aluminum, titanium, chromium, and combinations of the foregoing. The stabilizing metal ions may be added at a concentration in the range of about 0.0001M to saturation, preferably from about 0.0005M to about 0.5M and most preferably from about 0.001M to about 0.05M.

The inventors have found that by adding suitable concentrations of these one or more stabilizing metal ions to the manganese(II)-based etching solution, the formation of unwanted manganese dioxide during long-term operation of the etching solution can be eliminated or reduced. In one embodiment, the amount of unwanted manganese dioxide, is less than about 0.01M, or less than about 0.005 M, or less than 0.001 M.

The etching solution is preferably contained in a tank and the surface of the substrate is contacted with etching solution by immersing the substrate into the tank. The presence of the stabilizing metal ions also allows the surfaces of the tank to remain free of any visible formation of manganese dioxide precipitate. That is, by preventing the formation of manganese dioxide in the manganese(III)-based etching solution, manganese dioxide precipitate is at least substantially suppressed and/or eliminated and does not build up on surfaces of the tank.

Manganese(III)-based etching solutions of the invention typically contain dissolved manganese(II) ions and dissolved manganese(III) ions. In one embodiment, the etching solution contains about 0.1M manganese, although the concentration of manganese can be from 0.001M up to the limit of solubility. The manganese ions can be added as a soluble manganese salt. For example, the manganese ions may be selected from the group consisting of manganese(II)sulphate, manganese(II)chloride, manganese(H)carbonate, manganese(II)nitrate, manganese(II) methanesulphonate and combinations of one or more of the foregoing. Other manganese salts with a suitable counter-ion would also be known to those skilled in the art and would be usable in the present invention. By this definition, a suitable counter-ion is one that does not have a negative effect on the etching solution operation and thus includes counterions that are soluble and stable in the solution, or counterions that may be eliminated during dissolution, which may include, for example, carbonate which is eliminated as carbon dioxide by reaction with the strong acid solution.

Manganese(III)-based etching solutions have very high acidity (i.e., greater than about 18M molar acidity), which typically comprises inorganic acids but can also contain organic acids that are stable in the etching solution. Typically acids include, but are not limited to inorganic acids such as sulphuric acid, nitric acid, phosphoric acid and hydrochloric acid, organosulphonic acids such as methanesulphonic acid or toluenesulphonic acid, and perhalo acids such as periodic acid. The acid is not restricted as any acid with a counter-ion that is soluble and stable in the etching solution may be used. Combinations of one or more suitable acids may be used.

The manganese(III) species in the manganese(III)-based etching solution may be generated by electrolysis, with the oxidation of manganese(II) ion to manganese(I) ions occurring at the anode surface. Suitable electrodes include, for example, lead, tin/lead alloy, platinum and platinised substrates (e.g., titanium, tantalum or niobium), carbon, boron-doped diamond and metal-oxide (e.g., tantalum/iridium mixed oxide) coated substrates. Particularly preferred are platinized niobium electrodes. However, any electrode that is stable in the etching solution and that is capable of oxidising manganese(II) to manganese(II) can be used.

Alternatively, an oxidising agent can be added to the manganese(III)-based etching solution to oxidise manganese(II) to manganese(III) directly. Suitable oxidising agents include, for example, periodate ions, permanganate ions, chromium(VI) oxide and lead dioxide. Preferred oxidising agents are those that do not create by their action a by-product that causes a detrimental effect to the etching solution. One preferred oxidising agent is potassium permanganate, by which action the permanganate ion is correspondingly reduced to manganese(II).

Depending on the particular substrates being treated, the manganese(III)-based etching solutions may be operated at temperatures ranging from room temperature to about 100° C. but typically at about 60 to about 75° C. The immersion time for substrates to be etched can vary from about 1 to about 60 minutes but about 5 to about 30 minutes is typical.

During operation, manganese(I) ions of the manganese(III)-based etching solution oxidise the substrate and are in turn returned back to manganese(II) form. Therefore, for continuous operation, continual re-oxidation of the manganese(II) is required and the preferred means for this is by electrolytic oxidation because it avoids the need for the continuous addition of oxidising agent into the etching solution.

Manganese(III)-based etching solutions typically have a very high acid concentration in the range of greater than about 18 molar acidity and typically in the range of about 20 to about 25 molar acidity, as measured as a monobasic acid. In such etching solutions, the partial vapour pressure of water in the etching solution can be lower than that in the ambient atmosphere and this leads to the absorption of water from the atmosphere into the etching solution. As a result, a slow but continual dilution of the etching solution and a consequent reduction in the etching ability of the etching solution is achieved.

In continuous operation, this can be controlled by the use of an evaporation system such as disclosed in U.S. Pat. Pub. No. 2017/0088971 to Herdman et al., the subject matter of which is herein incorporated by reference in its entirety. In such a treatment, the etching solution can be continuously treated by passing it through a chamber containing dried air, and in this chamber excess moisture can be removed from the etching solution. Alternatively, a portion of the etching solution can be removed, treated independently to remove excess moisture, and returned to the etching solution. Carrying out such treatments on a portion of the etching solution can be done on a feed-and-bleed basis that will be known to those with knowledge of the art. An advantage of treating a separated portion of the etching solution is that the temperature can be increased to higher than the normal operating temperature of the etching solution in order to increase the partial vapour pressure of water and thus the rate of moisture removal from the treated portion of the etching solution. However, in the case of manganese(III)-based etching solutions, an increase in temperature can result in reduced solution stability and thus an increased tendency for the formation and precipitation of manganese dioxide.

Additionally under conditions where manganese(II) is in a low concentration, the electrolytic oxidation of manganese(III) further to manganese dioxide occurs more readily which again can lead to the production of manganese dioxide precipitate in the etching solution.

Thus a means of eliminating or reducing the formation of manganese dioxide is highly desirable to overcome some of the limitations as described.

Thus, as described herein, the undesirable formation of manganese dioxide can be reduced by the addition of the selected stabilizing metal ions to the manganese(III)-based etching solution. These selected stabilizing metal ions can be used singly or in combination. The presence of the stabilizing metal ions in the manganese(II)-based etching solution eliminates or at least substantially reduces the formation of manganese dioxide precipitate in the etching solution.

In another embodiment, the present invention also relates generally to a process for stabilizing a manganese(III)-based etching solution for treating a substrate comprising one or more polymers, wherein the manganese(III)-based etching solution is contained in a system comprising a tank and comprises (i) at least one source of manganese(II) ions; (ii) at least one source of manganese(III) ions and (iii) at least one acid that provides >18M acidity on a monobasic acid basis, the process including the steps of:
(a) providing a substrate comprising one or more polymers; and
(b) contacting the substrate comprising the one or more polymers with the manganese(II)-based etching solution to etch a surface of the substrate by immersing the substrate into the tank containing the etching solution;
wherein formation of manganese dioxide in the etching solution is suppressed by adding one or more stabilizing metal ions, wherein the one or more stabilizing metal ions are selected from the group consisting of aluminum, titanium, chromium, and combinations thereof.

The surfaces of the system comprising the tank remain free of any visible formation of manganese dioxide precipitate for an extended period of time, which extended period of time may be at least several months or at least a year or longer.

In a first aspect of the invention, the formation of manganese dioxide in the manganese(III)-based etching solution is suppressed while an etchable substrate is immersed in the etching solution.

In a second aspect of the invention, the formation of manganese dioxide in the manganese(III)-based etch solution is suppressed while the etching solution stands unused between etching operations.

In a third aspect of the invention the formation of manganese dioxide in the manganese(III)-based etching solution is suppressed while the etching solution is being treated to remove excess moisture from the etching solution.

By suppressing the formation of manganese dioxide in the manganese(III)-based etching solution, the build-up of manganese dioxide precipitation on the sides of the tank and equipment is eliminated or reduced and the loss of production time to allow for tank cleaning is eliminated or reduced. Additionally the size of equipment for moisture removal can be reduced because faster removal of moisture can be achieved by allowing the etching solution to be heated above normal operating temperature during production-off time whilst avoiding the formation of manganese dioxide.

The inventors have found that preferred stabilizing metal ions include aluminum, titanium, chromium, and combinations of the foregoing, all of which are suitable stabilizing ions. In one embodiment, the most preferred stabilizing metal ion is titanium.

The stabilizing metal ions may be present in concentrations ranging from about 0.0001M to saturation, preferably from about 0.0005M to about 0.5M and most preferably from about 0.001 to about 0.05M.

The stabilizing metal ions can be introduced into the manganese(III)-based etching solution by any means. For example, the stabilizing metal ions can be added directly to the etching solution as a soluble metal salt. The oxidation state of the metal in the metal salt is not critical because the metal ions will become oxidised or reduced in the etching solution to form the stable state in the etching solution environment. For example, chromium(VI) can be added to the etching solution and would form chromium(III), with the accompanying conversion of manganese(II) to manganese(III). Titanium(III) can be added to the etching solution and would be oxidised to titanium(IV). Metal ions that are added in the oxidation state that is already stable in the etching solution do not undergo any change in oxidation state (e.g. aluminum(III)).

Salts such as sulphate, chloride, carbonate, phosphate and nitrate salts are suitable for adding the stabilizing metal. However, any salt that is soluble and with a suitable counter-ion can be used. A suitable counter-ion is one that does not have a negative effect on the etching solution operation and thus includes counterions that are soluble and stable in the etching solution, or counterions that may be eliminated during dissolution, for example carbonate, hydroxide or oxide salts, or organic salts.

By way of example and without limitation, suitable titanium salts include, but are not limited to, titanium(III)chloride, titanium(IV)chloride, titanium(III)nitrate and titanium(IV)oxysulphate (also known as titanyl sulphate); suitable aluminum salts include, but are not limited to, aluminum sulphate, aluminum chloride, aluminum hydroxide or aluminum oxide and suitable chromium salts include, but are not limited to, chromium(I)chloride, chromium(III)hydroxide sulphate (also known as chrometan), chromium (III) oxide, chromium (VI) oxide, chromium(III)carbonate, chromium(III)phosphate, sodium dichromate and chromium(III)acetate.

Alternatively the stabilizing metal ions can be introduced to the manganese(III)-based etching solution by the direct dissolution of metal in the solution. Titanium, aluminum and chromium ions can be introduced in the etching solution by immersing the metal in the etching solution until the desired amount of metal has dissolved. Direct dissolution of metal may be accelerated by the application of a suitable cell voltage, for example by suspending a piece of metal in the etching solution as an electrode in an electrical circuit. Alternatively the desired amount of metal can be added to the etching solution as fine metal powder and dissolution happens until finally all the metal is dissolved.

The manganese(III)-based etching solution containing the stabilizing metal ions may be a single solution in which both sets of electrodes (anodes and cathodes) are immersed. Alternatively the etching solution may be the anolyte in a split cell and have only the anodes immersed, with the cathodes immersed in a separate catholyte solution separated from the anolyte by a suitable membrane. For example, a fluoropolymer membrane (a suitable example of which is a perfluorosulfonic acid membrane based on a PFSA/PTFE copolymer, a commercial product of which is available from Chemours, under the tradename Nafion™) or a porous ceramic membrane would be suitable. Such a split cell arrangement allows for the stabilizing metal ions to be added only to the anolyte.

The invention will now be illustrated with the following non-limiting examples.

### Reference Example 1

An etching solution was prepared according to U.S. Pat. No. 10,280,367, containing 0.12M manganese sulphate, 10.3M sulphuric acid and 1.6M methanesulphonic acid. The solution was a pale pink colour typical of manganese(II) solutions. The solution was electrolysed at 70° C. at an anodic current density of 1.5 A/dm² and a cathodic current density of 5 A/dm² using platinised niobium electrodes.

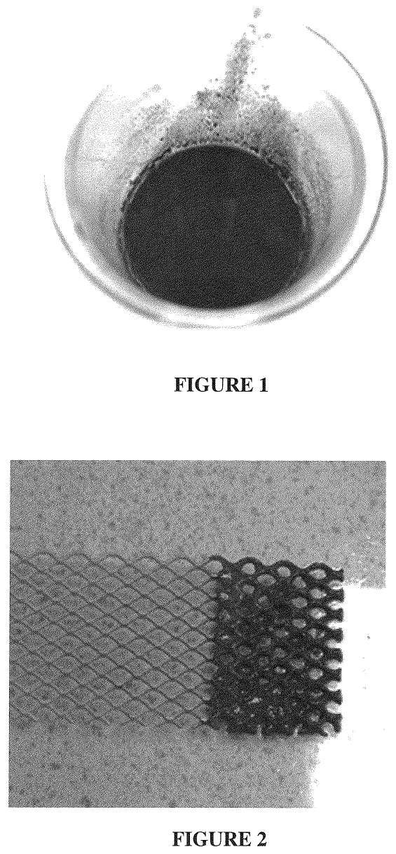

After 3.5 hours of electrolysis the solution was a deep purple colour consistent with presence of the manganese(III) species. Analysis indicated a concentration of 0.074M manganese(III). The manganese(III) ion concentration was determined by redox titration in a strongly acidic mixture with 0.1N ferrous ammonium sulphate using diphenylamine as an indicator; for a 10 ml sample of etching solution, the manganese(I) ion molarity was calculated by multiplying the titration figure by 0.01. The electrolysed solution was left standing at room temperature and the long-term stability of the solution was evaluated. After 1 day a noticeable amount of brown sludge had formed and settled in the bottom of the beaker, indicating the presence of manganese dioxide precipitate as shown in FIG. 1.

### Reference Examples 2-10

Solutions were prepared and electrolysed as in Reference Example 1 with different metal ions suggested by U.S. Pat. No. 9,752,074 or U.S. Pat. No. 10,174,250 being added to the solution at similar concentrations. The electrolysed solutions were then left standing at room temperature for up to 10 days and the long-term stability of the solution was evaluated. The results of these examples are shown in Table 1.

FIG. 2 depicts black sludge formed during electrolysis in accordance with Reference Example 5 that used bismuth as the source of stabilizing metal ions.

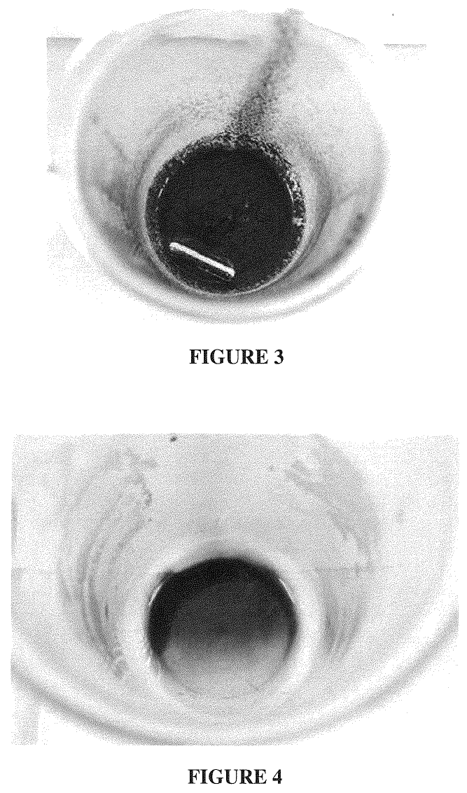

FIG. 3 depicts brown precipitate formed when using iron as the source of stabilizing metal ions. As shown in FIG. 3, a brown sludge was observed when using iron as the source of stabilizing metal ions in a similar amount as in Reference Example 1 that did not contain any stabilizing metal ions, thus demonstrating that iron had no effect at all on stabilizing the solution to prevent manganese

### Invention Examples 11-1.3

Solutions were prepared and electrolysed as in Reference Example 1 with different metal ions of the invention (i.e., Al, Ti, and Cr) added to the solution at similar concentrations as in Reference Examples 2-10. The electrolysed solutions were then left standing at room temperature for up to 10 days and the long-term stability of the solution was evaluated. The results of these examples are also shown in Table 1.

TABLE 1
Results of Examples 1-13

| | | Metal ion | Predicted | Mn(III) | | |
|---|---|---|---|---|---|---|
| | | conc. | stable | conc. | Bath | |
| Example | Metal salt | (M) | state | (M) | stability | Comments |
| Ref. Ex. 1 | none | — | — | 0.074 | ▪ | Reference |
| Ref. Ex. 2 | Ag₂CO₃ | 0.0046 | Ag(I) | 0.024 | ▪ | no effect |
| Ref. Ex. 3 | CuSO₄ | 0.008 | Cu(II) | 0.056 | ▴ | no effect |
| Ref. Ex. 4 | NaMoO₄ | 0.0052 | Mo(VI) | 0.058 | ▪ | no effect |
| Ref. Ex. 5 | Bi(CH₃SO₃)₃ | 0.014 | Bi(III) or | 0.056 | ▴ | no effect |
| | | | Bi(V) | | | |
| Ref. Ex. 6 | NaVO₄ | 0.01 | V(V) | 0.09 | ▪ | no effect |
| Ref. Ex. 7 | Fe₂(SO₄)₃ | 0.009 | Fe(III) | 0.050 | ▪ | no effect |
| Ref. Ex. 8 | NiSO₄ | 0.0085 | Ni(II) | 0.084 | ▪ | no effect |
| Ref. Ex. 9 | ZnSO₄ | 0.0076 | Zn(II) | 0.082 | ▪ | no effect |
| Ref. Ex. 10 | Zr(SO₄)₂ | 0.0055 | Zr(IV) | 0.082 | ▪ | no effect |
| Ex. 11 | Al₂(SO₄)₃ | 0.018 | Al(III) | 0.066 | ◯ | Improved bath |
| | | | | | | stability |
| Ex. 12 | TiOSO₄ | 0.01 | Ti(IV) | 0.084 | ◯ | improved bath |
| | | | | | | stability |
| Ex. 13 | CrOHSO₄ | 0.01 | Cr(III) | 0.096 | ◯ | improved bath |
| | | | | | | stability |

▪-Significant MnO₂ precipitate formed in less than 1 day
▴-Black sludge formed during electrolysis
◯-No significant MnO₂ precipitate, only a small amount of fine residue in bottom of beaker

The results in Table 1 clearly show that most of the metal ions described in prior art as being suitable for use in preventing manganese dioxide formation resulting from the decomposition of manganese(VII) in permanganate etching solutions were completely ineffective in preventing the formation of manganese dioxide in manganese(III)-based etching solutions. Thus, it was surprisingly found that only the addition of aluminum ions, chromium ions, and/or titanium ions to a manganese(III)-based etching solution was able to provide the desirable result of improving bath stability, while none of the remaining ions described for stabilization of a permanganate etching solution had any effect on bath stability when used in a manganese(III)-based etching solution. The advantages of the use of metal ions of the invention in a manganese(III)-based etching solution are clearly demonstrated by a reduction in the formation of manganese dioxide in the solution. Furthermore, while the addition of copper ions had a significant effect on bath stability in a permanganate-based solution and was demonstrated as being most preferred for stabilizing the manganese(VII) ions, the addition of copper ions to a manganese(III)-based etching solution had no effect on bath stability.

### Reference Example 14

An etching solution was prepared according to U.S. Pat. No. 10,280,367 containing 0.12M manganese sulphate, 10.3M sulphuric acid, 1.6M methanesulphonic acid and 0.9M phosphoric acid. The solution was a pale pink colour typical of manganese (I) solutions. The solution was electrolysed at 70° C. at an anodic current density of 1.5 A/dm² and a cathodic current density of 6 A/dm² using platinised niobium electrodes.

After 8 hours of electrolysis the solution was a deep purple colour consistent with presence of the manganese (III) species. Analysis indicated a concentration of 0.090M of manganese(II). The long-term stability of the solution was evaluated by standing for 2 weeks and thereafter being heated to 95° C. during daytime hours. During the heated period, a small amount of air was bubbled through the solution. After 4 days of the heating period a noticeable amount of brown sludge had formed and settled in the bottom of the beaker, indicative of manganese dioxide formation as shown in FIG. 4.

### Invention Example 15

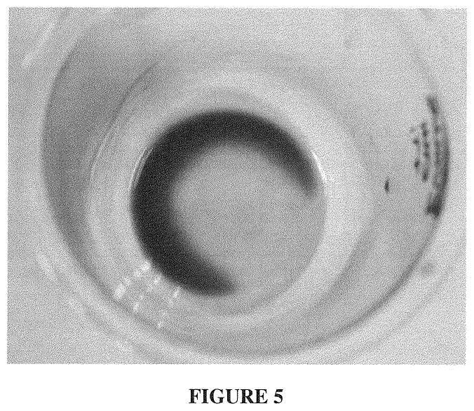

An etching solution was prepared and electrolysed as in Reference Example 14, with 0.002M titanium added in the form of titanyl sulphate. After electrolysis, analysis indicated a concentration of 0.086M of manganese(III). The long-term stability of the solution was evaluated as in reference example 14 and after 14 days of heating to 95° C. during the daytime the etching solution remained free of manganese dioxide precipitate as shown in FIG. 5.

### Invention Example 16

An etching solution was prepared and electrolysed as in Reference Example 14, with 0.018M aluminum added in the form of aluminum sulphate. After electrolysis, analysis indicated a concentration of 0.080M of manganese(III). The long-term stability of the solution was evaluated as in reference example 14 and after 11 days of heating to 95° C. during the daytime the etching solution remained free of manganese dioxide precipitate.

### Invention Example 17

An etching solution was prepared and electrolysed as in Reference Example 14, with 0.010M chromium added in the form of chromium hydroxy sulphate (commercially known as Chrometan). After electrolysis, analysis indicated a concentration of 0.078M of manganese(III). The long-term stability of the solution was evaluated as in reference example 14 and after 14 days of heating to 95° C. during the daytime the etching solution remained free of manganese dioxide precipitate.

### Reference Example 18

An etching solution was prepared according to U.S. Pat. No. 10,280,367 containing 0.09M manganese sulphate, 9.5M sulphuric acid, 3.0M methanesulphonic acid and 0.5M phosphoric acid. The solution was a pale pink colour typical of manganese (II) solutions. The solution was electrolysed at 70° C. at an anodic current density of 1.5 A/dm² and a cathodic current density of 6 A/dm² using platinised niobium electrodes.

After 8 hours of electrolysis the solution was a deep purple colour consistent with presence of the manganese (III) species. Analysis indicated a concentration of 0.074M of manganese(III). The long-term stability of the solution was evaluated by standing for 4 weeks and thereafter being heated to 70° C. during daytime hours. During the heated period, a small amount of air was bubbled through the solution. After 19 days a noticeable amount of brown sludge had formed and settled in the bottom of the beaker, indicative of manganese dioxide formation.

### Invention Example 19

An etching solution was prepared and electrolysed as in Reference Example 18, with 0.008M titanium added in the form of titanyl sulphate. After electrolysis, analysis indicated a concentration of 0.072M of manganese(III). The long-term stability of the solution was evaluated as in reference example 18 and after 35 days of heating to 70° C. during the daytime the etching solution remained free of manganese dioxide precipitate.

### Invention Example 20

An etching solution was prepared and electrolysed as in Reference Example 14, with 0.015M titanium added in the form of titanyl sulphate. After electrolysis, analysis indicated a concentration of 0.086M of manganese(III). The long-term stability of the solution was evaluated as in Reference Example 18 and after 35 days of heating to 70° C. during the daytime the etching solution remained free of manganese dioxide precipitate.

### Invention Example 21

An etching solution was prepared and electrolysed as in Reference Example 14, with 0.008M of titanium added by immersing commercial titanium metal mesh in the solution until a concentration of 0.008M was achieved, after which time the titanium mesh was removed from the solution. The solution exhibited a blue colour indicating the presence of titanium (I) ions. During subsequent electrolysis, the blue colour faded indicating conversion of titanium (III) to titanium (IV) before the purple colour of manganese(III) began to appear. After electrolysis, analysis indicated a concentration of 0.072M of manganese(III). The long-term stability of the solution was evaluated as in reference example 18 and after 35 days of heating to 70° C. during the daytime the etching solution remained free of manganese dioxide precipitate.

The results from Reference Examples 14 and 18, and Invention Examples 15-17 and 19-21 are shown in Table 2.

TABLE 2
Long Term Stability Results of Examples 14 to 21

| | | Metal ion | Predicted | Mn(iii) | Long-term | |
|---|---|---|---|---|---|---|
| | | conc. | stable | conc. | stability | |
| Example | Metal salt | (M) | state | (M) | when heated | Comment |
| Ref. Ex. 14 | — | 0 | — | 0.090 | 1 | Reference |
| Ex. 15 | TiOSO₄ | 0.002 | Ti(IV) | 0.086 | 4 | improved bath |
| | | | | | | stability |
| Ex. 16 | Al₂(SO₄)₃ | 0.018 | Al(III) | 0.080 | 3 | improved bath |
| | | | | | | stability |
| Ex. 17 | CrOHSO₄ | 0.010 | Cr(III) | 0.078 | 4 | improved bath |
| | | | | | | stability |
| Ref. Ex. 18 | — | 0 | — | 0.074 | 2 | Reference |
| Ex. 19 | TiOSO₄ | 0.008 | Ti(IV) | 0.072 | 5 | improved bath |
| | | | | | | stability |
| Ex. 20 | TiOSO₄ | 0.015 | Ti(IV) | 0.086 | 5 | improved bath |
| | | | | | | stability |
| Bx. 21 | Ti added by | 0.008 | Ti(IV) | 0.072 | 5 | improved bath |
| | dissolving Ti | | | | | stability |
| | metal | | | | | |

1-Visible MnO₂ formation within 4 days when heated to 95° C. during daytime
2-Visible MnO₂ formation within 19 days when heated to 70° C. during daytime
3-No MnO₂ formation after 11 days when heated to 95° C. during daytime
4-No MnO₂ formation after 14 days when heated to 95° C. during daytime
5-No MnO₂ formation after 35 days heating to 70° C. during daytime

The results in Table 2 demonstrate the advantages of the metal ions of the invention over the reference examples which contains none of the metal ions of the invention.

Once the substrate has been etched by the process described herein, the substrate can be rinsed and plated according to steps currently known in the art. One example of a suitable set of steps for metallizing the etched substrate includes the following:
1) Treatment in a proprietary preparation for plating on plastic (i.e., M-Neutralize, available from MacDermid, Inc)
2) Rinse
3) Pre-dip in 30% hydrochloric acid
4) Activate in a proprietary palladium colloid activator (Macuplex D34 C, available from MacDermid, Inc.)
5) Rinse
6) Accelerate in a proprietary preparation (Macuplex Ultracel 9369, available from MacDermid, Inc.)
7) Rinse
8) Plate in electroless nickel process (Macuplex J64, available from MacDermid, Inc.)
9) Rinse
10) Plate in acid copper process to a desired thickness (CuMac Optima, available from MacDermid)

### Additional Embodiments

Embodiment 1: An etching solution for treating plastic surfaces comprising:
dissolved manganese(II) ions and dissolved manganese(III) ions;
at least one acid, wherein the at least one acid has a concentration of at least 18 molar acidity; and
at least one stabilizing metal ion selected from the group consisting of aluminum, titanium, chromium, and combinations thereof.

Embodiment 2: The etching solution of Embodiment 1, wherein said etching solution is at least substantially free of manganese dioxide, preferably wherein the etching solution contains less than about 0.01M manganese dioxide, more preferably wherein the etching solution contains less than about 0.005M manganese dioxide, more preferably wherein the etching solution contains less than about 0.001M manganese dioxide.

Embodiment 3: The etching solution of Embodiment 1 or Embodiment 2, wherein a portion of the manganese(H) ions are oxidized to manganese(III) ions by electrolysis.

Embodiment 4: The etching solution of Embodiment 1 or Embodiment 2, wherein a portion of the manganese(ii) ions are oxidized to manganese(III) ions by an oxidizing agent, wherein the oxidizing agent is selected from the group consisting of periodate ions, permanganate ions, chromium(VI) oxide, lead dioxide, and combinations thereof, preferably wherein the oxidizing agent comprises potassium permanganate.

Embodiment 5: The etching solution of any of the preceding Embodiments, wherein the manganese(II) ions are added as a soluble manganese salt, optionally wherein the soluble manganese salt is selected from the group consisting of manganese(II)sulphate, manganese(II)chloride, manganese(II)carbonate, manganese(II)nitrate, manganese (II)methanesulphonate and combinations of one or more of the foregoing.

Embodiment 6: The etching solution of any of the preceding Embodiments, wherein the at least one acid is selected from the group consisting of inorganic acids, organosulphonic acids, perhalo acids, and combinations of the foregoing, optionally, wherein the at least one acid is selected from the group consisting of sulfuric acid, nitric acid, phosphoric acid, hydrochloric acid, methanesulphonic acid, toluenesulphonic acid, periodic acid, and combinations of the foregoing or wherein the at least one acid comprises sulfuric acid.

Embodiment 7: The etching solution of any of the preceding Embodiments, wherein the concentration of the at least one acid is in the range of about 20 molar acidity to about 25 molar acidity.

Embodiment 8: The etching solution according to any of Embodiments 1 to 7, wherein the stabilizing metal ions are added to the etching solution as a soluble metal salt.

Embodiment 9: The etching solution according to Embodiment 8, wherein the soluble metal salt is selected from the group consisting of titanium(III)chloride, titanium(IV)chloride, titanium(III)nitrate, titanium(IV)oxysulphate, aluminum sulphate, aluminum chloride, aluminum hydroxide, aluminum oxide, chromium(III) chloride, chromium(III)hydroxide sulphate, chromium(III) oxide, chromium (VI) oxide, chromium(III)carbonate, chromium(III)phosphate, sodium dichromate chromium(I)acetate, and combinations of one or more of the foregoing.

Embodiment 10: The etching solution according to any of Embodiments 1 to 7, wherein the stabilizing metal ions are introduced into the etching solution by direct dissolution of metal in the solution.

Embodiment 11: The etching solution of any of the preceding Embodiments, wherein the concentration of the stabilizing metal ions is in the range of about 0.0001M to saturation, preferably wherein the concentration of the stabilizing metal ions is in the range of about 0.0005M to about 0.5M, preferably wherein the concentration of the stabilizing metal ions is in the range of about 0.001M to about 0.05M.

Embodiment 12: A process comprising:
(a) providing a substrate comprising one or more polymers;
(b) providing an etching solution according to any of Embodiments 1 to 11; and
(c) contacting a surface of the substrate comprising the one or more polymers with the etching composition to etch the surface of the substrate.

Embodiment 13: The process of Embodiment 12, wherein the etching solution is contained in a tank and the substrate is contacted with etching solution by immersing the substrate into the tank, and wherein surfaces of the tank remain free of any visible formation of manganese dioxide precipitate.

Embodiment 14: The process of Embodiment 12 or Embodiment 13, wherein the one or more polymers are selected from the group consisting of ABS, PC, and combinations of ABS/PC.

Embodiment 15: The process of any of Embodiments 12 to 14, further comprising the step of metallizing the etched surface of the substrate.

Embodiment 16: A process for stabilizing an etch solution for treating a substrate comprising one or more polymers, wherein the etch solution is contained in a system comprising a tank and comprises (i) at least one source of manganese(II) ions; (ii) at least one source of manganese(III) ions and (iii) at least one acid, wherein the at least one acid has a concentration of at least 18 molar acidity, the process including the steps of:
(a) providing a substrate comprising one or more polymers; and
(b) contacting the substrate comprising the one or more polymers with the etch solution to etch a surface of the substrate by immersing the substrate into the tank containing the etch solution;
wherein formation of manganese dioxide in the etch solution is suppressed by adding one or more stabilizing metal ions, wherein the one or more stabilizing metal ions are selected from the group consisting of aluminum, titanium, chromium and combinations thereof.

Embodiment 17: The process according to Embodiment 16, wherein the one or more stabilizing metal ions are added to etch solution while the substrate is immersed in the tank containing the etch solution.

Embodiment 18: The process according to Embodiment 15, wherein the one or more stabilizing metal ions are added to the etch solution while the tank containing the etch solution stands unused between etching operations.

Embodiment 19: The process according to Embodiment 16, wherein at least a portion of the etch solution is removed from the tank and treated to remove excess moisture from the etch solution and the one or more stabilizing metal ions are added to the etch solution while the etch solution is being treated.

Embodiment 20: The process according to any of Embodiments 16 to 19, wherein the stabilizing metal ions are added to the etching solution as a soluble metal salt, optionally wherein the soluble metal salt is selected from the group consisting of titanium(II)chloride, titanium(IV)chloride, titanium(III)nitrate, titanium(IV)oxysulphate, aluminum sulphate, aluminum chloride, aluminum hydroxide, aluminum oxide, chromium(III) chloride, chromium(III)hydroxide sulphate, chromium(III) oxide, chromium (VI) oxide, chromium(III)carbonate, chromium(III)phosphate, sodium dichromate chromium(III)acetate, and combinations of one or more of the foregoing.

Embodiment 21: The process of any of Embodiments 16 to 19, wherein the stabilizing metal ions are introduced into the etching solution by direct dissolution of metal in the solution.

Embodiment 22: The process of any of Embodiments 16 to 21, wherein surfaces of the system comprising the tank remain free of any visible formation of manganese dioxide precipitate for an extended period of time, preferably in which extended period of time may be at least several months or at least a year or longer.

What is claimed is:

1. A manganese(III)-based etching solution for treating plastic surfaces comprising:
dissolved manganese(II) ions and dissolved manganese(III) ions;
at least one acid, wherein the at least one acid has a concentration of at least 18 molar acidity; and
at least one stabilizing metal ion selected from the group consisting of aluminum, titanium, chromium, and combinations thereof.

2. The manganese(III)-based etching solution of claim 1, wherein said etching solution is at least substantially free of manganese dioxide.

3. The manganese(III)-based etching solution of claim 2, wherein the etching solution contains less than about 0.01M manganese dioxide.

4. The manganese(III)-based etching solution of claim 3, wherein the etching solution contains less than about 0.005M manganese dioxide.

5. The manganese(III)-based etching solution of claim 4, wherein the etching solution contains less than about 0.001M manganese dioxide.

6. The manganese(III)-based etching solution of claim 1, wherein a portion of the manganese(II) ions are oxidized to manganese(III) ions by electrolysis.

7. The manganese(III)-based etching solution of claim 1, wherein a portion of the manganese(II) ions are oxidized to manganese(III) ions by an oxidizing agent, wherein the oxidizing agent is selected from the group consisting of periodate ions, permanganate ions, chromium(VI) oxide, lead dioxide, and combinations thereof.

8. The manganese(III)-based etching solution of claim 7, wherein the oxidizing agent comprises potassium permanganate.

9. The manganese(III)-based etching solution of claim 1, wherein the manganese(II) ions are added as a soluble manganese salt.

10. The manganese(III)-based etching solution of claim 9, wherein the soluble manganese salt is selected from the group consisting of manganese(II)sulphate, manganese(II)chloride, manganese(II)carbonate, manganese(II)nitrate, manganese (II)methanesulphonate and combinations of one or more of the foregoing.

11. The manganese(III)-based etching solution of claim 1, wherein the at least one acid is selected from the group consisting of inorganic acids, organosulphonic acids, perhalo acids, and combinations of the foregoing.

12. The manganese(III)-based etching solution of claim 11, wherein the at least one acid is selected from the group consisting of sulfuric acid, nitric acid, phosphoric acid, hydrochloric acid, methanesulphonic acid, toluenesulphonic acid, periodic acid, and combinations of the foregoing.

13. The manganese(III)-based etching solution of claim 1, wherein the at least one acid comprises sulfuric acid.

14. The manganese(III)-based etching solution of claim 1, wherein the concentration of the at least one acid is in the range of about 20 molar acidity to about 25 molar acidity.

15. The manganese(III)-based etching solution according to claim 1, wherein the stabilizing metal ions are added to the etching solution as a soluble metal salt.

16. The manganese(III)-based etching solution according to claim 15, wherein the soluble metal salt is selected from the group consisting of titanium(III)chloride, titanium(IV)chloride, titanium(III)nitrate, titanium(IV)oxysulphate, aluminum sulphate, aluminum chloride, aluminum hydroxide, aluminum oxide, chromium(III) chloride, chromium(III)hydroxide sulphate, chromium(III) oxide, chromium (VI) oxide, chromium(III)carbonate, chromium(III)phosphate, sodium dichromate chromium(III)acetate, and combinations of one or more of the foregoing.

17. The manganese(III)-based etching solution according to claim 1, wherein the stabilizing metal ions are introduced into the etching solution by direct dissolution of metal in the solution.

18. The manganese(III)-based etching solution of claim 1, wherein the concentration of the stabilizing metal ions is in the range of about 0.0001M to saturation.

19. The manganese(III)-based etching solution of claim 18, wherein the concentration of the stabilizing metal ions is in the range of about 0.0005M to about 0.5M.

20. The manganese(III)-based etching solution of claim 19, wherein the concentration of the stabilizing metal ions is in the range of about 0.001M to about 0.05M.

21. A process comprising:
(a) providing a substrate comprising one or more polymers;
(b) providing a manganese(III)-based etching solution comprising:
(i) dissolved manganese(II) ions and dissolved manganese(III) ions;
(ii) at least one acid, wherein the at least one acid has a concentration of at least 18 molar acidity; and
(iii) at least one stabilizing metal ion selected from the group consisting of aluminum, titanium, chromium, and combinations thereof; and
(c) contacting a surface of the substrate comprising the one or more polymers with the etching solution to etch the surface of the substrate.

22. The process of claim 21, wherein said etching solution is at least substantially free of manganese dioxide.

23. The process of claim 21, wherein the etching solution contains less than about 0.01M manganese dioxide.

24. The process of claim 21, wherein the etching solution is contained in a tank and the surface of the substrate is contacted with etching solution by immersing the substrate into the tank, and wherein surfaces of the tank remain free of any visible formation of manganese dioxide precipitate.

25. The process of claim 21, wherein a portion of the manganese(II) ions are oxidized to manganese(III) ions by electrolysis.

26. The process of claim 21, wherein the at least one acid is selected from the group consisting of inorganic acids, organosulphonic acids, perhalo acids, and combinations of the foregoing.

27. The process of claim 21, wherein the concentration of the at least one acid is in the range of about 20 molar acidity to about 25 molar acidity.

28. The process of claim 21, wherein the concentration of the stabilizing metal ions is in the range of about 0.0001M to saturation.

29. The process of claim 28, wherein the concentration of the stabilizing metal ions is in the range of about 0.0005M to about 0.5M.

30. The process of claim 29, wherein the concentration of the stabilizing metal ions is in the range of about 0.001M to about 0.05M.

31. The process of claim 21, wherein the one or more polymers are selected from the group consisting of ABS, PC, and combinations of ABS/PC.

32. The process of claim 21, further comprising the step of metallizing the etched surface of the substrate.

33. A process for stabilizing a manganese(III)-based etching solution for treating a substrate comprising one or more polymers, wherein the etching solution is contained in a system comprising a tank and comprises (i) at least one source of manganese(II) ions; (ii) at least one source of manganese(III) ions and (iii) at least one acid, wherein the at least one acid has a concentration of at least 18 molar acidity, the process including the steps of:
(a) providing a substrate comprising one or more polymers; and
(b) contacting the substrate comprising the one or more polymers with the etching solution to etch a surface of the substrate by immersing the substrate into the tank containing the etching solution;
wherein formation of manganese dioxide in the etching solution is suppressed by adding one or more stabilizing metal ions, wherein the one or more stabilizing metal ions are selected from the group consisting of aluminum, titanium, chromium, and combinations thereof.

34. The process according to claim 33, wherein the one or more stabilizing metal ions are added to etching solution while the substrate is immersed in the tank containing the etching solution.

35. The process according to claim 33, wherein the one or more stabilizing metal ions are added to the etching solution while the tank containing the etching solution stands unused between etching operations.

36. The process according to claim 33, wherein at least a portion of the etching solution is removed from the tank and treated to remove excess moisture from the etching solution and the one or more stabilizing metal ions are added to the etching solution while the etching solution is being treated.

37. The process according to claim 33, wherein the stabilizing metal ions are added to the etching solution as a soluble metal salt.

38. The process according to claim 37, wherein the soluble metal salt is selected from the group consisting of titanium(I)chloride, titanium(IV)chloride, titanium(III)nitrate, titanium(IV)oxysulphate, aluminum sulphate, aluminum chloride, aluminum hydroxide, aluminum oxide, chromium(III) chloride, chromium(II)hydroxide sulphate, chromium(III) oxide, chromium (VI) oxide, chromium(III)carbonate, chromium(III)phosphate, sodium dichromate chromium(III)acetate, and combinations of one or more of the foregoing.

39. The process of claim 33, wherein the stabilizing metal ions are introduced into the etching solution by direct dissolution of metal in the solution.

40. The process of claim 33, wherein surfaces of the system comprising the tank remain free of any visible formation of manganese dioxide precipitate for an extended period of time.

41. The process of claim 40, wherein surfaces of the system comprising the tank remain free of any visible formation of manganese dioxide precipitate for at least several months or at least a year or longer.
